(19) United States
(12) Patent Application Publication
(10) Pub. No.: US 2012/0036767 A1
(43) Pub. Date: Feb. 16, 2012

(54) CONTINUOUS CULTIVATION, HARVESTING, AND EXTRACTION OF PHOTOSYNTHETIC CULTURES

(76) Inventor: Mario C. Larach, San Diego, CA (US)

(21) Appl. No.: 13/057,747

(22) PCT Filed: Aug. 4, 2009
(86) PCT No.: PCT/US09/52762

§ 371 Date: May 2, 2011

Related U.S. Application Data
(60) Provisional application No. 61/086,106, filed on Aug. 4, 2008.

(51) Int. Cl. C10L 1/19; C10L 1/188; C11B 1/10

(52) U.S. Cl. 44/388; 554/8; 44/385

(57) ABSTRACT

The presently described invention relates to systems for continuously culturing, harvesting, and oil extraction of algal cultures for the production of algae oils.

### RELATED APPLICATIONS

This application claims the benefit of priority of U.S. Provisional Application No. 61/086,106, which is hereby incorporated by reference in its entirety.

### TECHNICAL FIELD

The disclosed invention relates to the continuous cultivation, harvesting, and oil extraction of photosynthetic microorganisms.

### BACKGROUND ART

There is a present and growing need for alternatives to fossil fuels. Major interest and investment has been made in the area of biofuels, which are fuels suitable for burning in standard internal combustion engines that are derived from biological sources. A particularly attractive biological source for biofuels is algae due, in part, to its substantially better yields (5000-10,000 gallons/acre/year) when compared to other feedstocks (300-700 gallons/acre/year). Certain strains of algae are particularly suited for fuel production because of desirable lipid profiles (e.g., lipid composition, lipid concentration as a percentage of mass).

Currently available algal biofuel production systems are costly and non-scalable resulting in production costs of $30 to $60 per gallon of biofuel. These current algae production systems are confronting two significant challenges—(1) the use of cost prohibitive closed cultivation systems and (2) an energy intensive, highly complex post cultivation process.

A cultivation system must provide access to sunlight for the photosynthetic process to occur and must allow a dominant microalgae species to grow unimpeded without the threat of “invading” strains. Today, to achieve both objectives, many closed systems use clear plastic bags or clear glass tubing.

These closed systems typically are designed to provide a protected environment that prevents the threat from “invading” species allowing for the cultivation of a monoculture of an algal strain possessing desirable traits. However, closed systems are unable to maintain strain stability for extended periods of time because of their exposure to the natural environment. Despite systems designed to exclude invasive, wild-type strains, entry points do exist (e.g., valves, connectors, and other mechanical components). Over a given period of time, the monoculture is ultimately invaded by one or more endemic, wild-type strains of algae that do not possess favorable traits for biofuel production. Once this occurs, the closed system ceases to be a monoculture of the desired strain, essentially “crashing” the cultivation process. A crashed system requires expensive and time consuming sterilization resulting in increased production costs and decreased yields.

Additionally, glass tube systems for monoculture must be periodically taken off line to remove biofilm build-up that occurs during the cultivation process. Tubes that are not cleaned gradually become opaque, limiting solar irradiation and becoming unsuitable for the growth of photosynthetic microorganisms. Bag systems are not typically cleaned, but instead are disposed of, and replaced with new bags. While the bag system eliminates the cleaning requirement of a tube system, it is both costly and, because of the petroleum base of plastic, environmentally less effective.

Another problem found in closed systems is the expensive cooling requirements to maintain an optimal growth medium temperature. Over the course of the cultivation cycle, substantial heat is generated by the photosynthetic process and then retained due to the green house effect. Without the natural venting that occurs in open systems (i.e., heat is dissipated naturally through exposure to air), closed production system trap and retain heat that would substantially damage the culture and reduce growth rates. As a result cooling systems are required for closed systems requiring additional costs and negatively impacting energy efficiency.

The total impact of these challenges with closed cultivation system result in high capital costs and high operating costs. As a result, microalgae cultivated in closed systems for biofuel are not economically viable.

Current post cultivation systems are energy intensive, highly complex, and cost prohibitive. Additionally, the process is batch oriented and non-continuous, creating barriers to large scale commercialization. It should be noted that in processes practiced presently, there are various additives, operating costs, and capital costs that drive up the cost of the process. In addition processing time is prohibitively high.

The first step in current post cultivation systems is the process of harvesting. Harvesting typically requires flocculation to concentrate the microalgae so that it can be subsequently removed from the growth medium. Induced flocculation is the most common method requiring the addition of a surfactant usually aluminum sulfate and ferric chloride or the commercial product Chitosan. Flocculation can take cultures with densities as low as 0.02-0.07% algae (˜1 gm algae/5000 gm water) and achieve suspension with up to 1% algae with 98% algae recovery. A second harvesting step is further required to achieve slurry concentrations of up to 3-4% algae. Dissolved air floatation is often used and is a process that clarifies the growth medium by the removal of suspended microalgae. The removal is achieved by dissolving air in the growth medium under pressure and then releasing the air at atmospheric pressure in a flotation tank or basin. The released air forms tiny bubbles which adhere to microalgae causing the suspended matter to float to the surface of the water where it may then be removed by a skimming device.

The second major step in post cultivation is primary and secondary dewatering. A significant bottleneck to large scale commercialization, dewatering is required to achieve a paste like consistency prior to extraction. Primary dewatering occurs using some combination of microfiltration and centrifuging to raise microalgae density to at least 6-8% of growth medium volume. Additional increases (up to 20% algae) can be achieved with more centrifuging and belt filter presses but at increased energy input and costs. Drying is required to achieve higher dry mass concentrations required for extraction. Because drying generally requires heat, methane drum dryers and other oven-type dryers have been used. However, the costs climb steeply with incremental temperature and/or time increases. Air-drying is possible in low-humidity climates, but will be require extra space and considerable time. After drying the remaining dewatered biomass is ready for extraction.

The third step in post cultivation processing is extraction. Extraction is the process by which the cell membrane or structure is ruptured or shattered so that oil within the cell is released and can be subsequently separated and processed. The most common extraction method is the addition of hexane solvent to the biomass. However the use of hexane presents substantial challenges. It is a volatile, flammable and explosive substance that the EPA categorizes as a HAP (hazardous air pollutant) and controls under the TRI (toxic release inventory) program. By inherent design, even the newest oil processing facilities lose hexane into the environment. It has been estimated that an average sized soybean facility loses 6,000 pounds of hexane per day to the environment through atmospheric leaks. Often coupled with hexane solvent is the oil press/expeller method that uses a mechanical press under high pressure to essentially squeeze out the oil. Subsequent costly recovery of the hexane is required.

The final post cultivation step is separation where the oil, remaining growth medium and organic matter are separated. A combination of both gravity flow mechanisms and centrifuging is used to attain the desired oil purity.

The demand for fossil fuels worldwide is staggering. According to a NREL study, the United States consumption of motor fuel is 390 million gallons a day or approximately 142 billion gallons a year. Accordingly, a future commercially viable biofuel production system needs to achieve dramatically reduced cost structure and substantial large scale production volumes.

The complexity, operational inefficiency and energy intensity of the current post cultivation process result in estimated production costs of $30 to $60 per gallon of algal biofuel and the current use of closed systems and complex post cultivation processes are less likely to provide a commercially viable alternative to fossil fuels.

In addition the numerous post cultivation processes are discrete batch-processes—requiring many costly, labor intensive, time consuming transitional steps to go from one process to another and thus do not lend themselves to a continuous and efficient production process.

### SUMMARY OF THE INVENTION

The presently described invention relates a method for the continuous harvesting, cultivation, and oil extraction of a photosynthetic microorganism, and the apparatus for performing the method. In a preferred embodiment the method comprises the steps of providing a cultivation container and a cultivation medium; introducing the photosynthetic microorganism into the medium; optimizing the medium to favor growth of the photosynthetic microorganism over other organisms; culturing the medium and the photosynthetic microorganism therein under conditions that facilitate the reproduction of the photosynthetic microorganism to a desired density; applying an extraction technique directly to a clarified cultivation medium thereby eliminating primary and secondary harvesting and primary and secondary dewatering, applying a separation technique directly to the medium after extraction, applying a method to treat, enrich and recycle the medium after separation, and the continuous returning of the recycled growth medium to the cultivation container; and repeating the steps of the method.

In a preferred embodiment the extraction method comprises the step of applying hydrodynamic cavitation to a continuous flow of microalgae in its growth medium to rupture the cell walls and extract the microalgae oil.

In a preferred embodiment the separation method comprises the step of coupling gravitational flow with hydro static flotation baffles to separate the oil, growth medium and organic matter.

In a preferred embodiment the treatment, enrichment and recycling method comprises the step of applying ultraviolet light coupled hydrodynamic cavitation to a continuous flow of medium after separation to eliminate bacteria, invasive photosynthetic organisms, and other unwanted organic matter thereby sterilizing the medium for reuse, and enhancing the culture medium for improved culture growth characteristics.

Another preferred embodiment of the invention comprises the harvesting of the cultured photosynthetic microorganism using fractionation and extracting the harvested biomass using hydrodynamic cavitation.

The invention further relates to the production of biofuels from the harvested material produced by the described methods.

### DETAILED DESCRIPTION OF THE INVENTION

The presently described invention relates to systems for continuously culturing, harvesting, and oil extraction of algal cultures for the commercial production of algae oils. The process typically involves the steps cultivation, extraction, separation, and recycling, each of which are discussed below. Preferably, the methods described herein do not require the addition of additives to effectively produce the product. Furthermore, the currently described methods have the advantage of being more cost effective and requiring shorter amounts of processing time.

The continuous fluid system combines a cost effective cultivation process with a substantially streamlined post cultivation process that eliminates the costly and energy intensive batch steps of primary and secondary harvesting and primary and secondary dewatering. The elimination of these batch steps has the additional advantage of extending the period that photosynthetic organisms can remain in growth mode before switching to lipid acquisition mode. For example, the diatom Chaetoceros sp. will attain 4 doublings per day in the continuous fluid systems versus 3 doublings a day in the current complex batch system. As a result yields will improve from 3500 gallons per acre per year to over 5500 gallons per acre per year.

The continuous fluid system is comprised of the following completely integrated and continuous through flow steps—(1) a cultivation process that maintains preferred strain dominance of photosynthetic organisms, (2) an extraction system that directly processes a clarified growth medium in a continuous moving flow to rupture the cell membrane and release algal oil, (3) a separation system that directly processes the moving flow from step 2 to separate oil, growth medium and organic matter and achieves 99.9% oil purity, and (4) a treatment, enrichment and recycling systems that directly processes the growth medium from Step 3 to eliminate bacteria and unwanted photosynthetic organisms, enrich the remaining growth medium by infusing required nutrients and then recycling the enriched growth medium back into the cultivation system.

In a preferred embodiment, one or more strains of photosynthetic organisms are selected for cultivation. The growth strain or strains is placed in a suitable cultivation system to expand the culture to a suitable density for harvesting. Once a desired density is achieved the culture medium flows to a clarifier where 20% of culture medium having 80% of the algae growth continuously flows through to extraction. The remaining medium remains in the cultivation system for self-inoculation. The extraction step ruptures or shatters the cell membrane using hydrodynamic cavitation allowing for the release of algal oil and other constituent components. Once 95% of oil has been released the medium flows directly through to separation. Using gravitational flow through hydro static flotation baffles, the oil, growth medium and organic matter are separated. The remaining growth medium flows directly to the treatment, enrichment and recycling process. Ultraviolet light coupled with hydrodynamic cavitation is used to sterilize the growth medium and infuse required nutrients. The flow is then recycled and returned for subsequent rounds of cultivation.

### Photosynthetic Microorganisms

The term “photosynthetic microorganism,” as used herein, includes all algae and microalgae capable of photosynthetic growth as well as photosynthetic bacteria. Eukaryotic algal strains are preferred for use with the disclosed methodology. Example include Botryococcene sp., Chlorella sp., Gracilaria sp., Sargassum sp., Spirolina sp., Dunaliella sp. (e.g., Dunaliella tertiolecta), Porphyridum sp., and Plurochrysis sp. (e.g., Plurochrysis carterae). Diatoms, such as Chaetoceros sp. are particularly preferred algal strains for use with the presently described invention. These terms may also include organisms modified artificially or by gene manipulation. For example, U.S. patent application Ser. No. 12/208,300, entitled, “ENGINEERED LIGHT-HARVESTING ORGANISMS,” which is hereby incorporated by reference in its entirety, discloses examples of organisms suitable for use with the disclosed methods.

Chaetoceros sp. is particularly well suited for use with the presently described invention. There are over 400 species and subspecies known throughout the world. The growth rate of this organism is rapid, with 3 to 4 doublings per day, permitting cultures to be grown quickly. These organisms are known to have broad tolerances to environmental conditions including temperature, salinity and solar irradiation. Chaetoceros sp. is also known to have a favorable lipid fraction (up to 40%), an attractive fatty acid profile, and when coupled with its high growth rate can naturally produce high yields of high quality algal oils.

A plurality of microorganisms can be used as the seed stock, where multiple photosynthetic microorganisms are used as the seed stock. Alternatively, a photosynthetic microorganism can be co-cultured with a beneficial non-photosynthetic microorganism.

### Cultivation

The microorganisms selected for culture can be grown by any conventional methods known to those of ordinary skill in the relevant art. Preferably optimal conditions for each organism are used. Optimal conditions are those that allow a seed stock of the photosynthetic microorganism to grow and outcompete contaminants and other unwanted organisms that can reduce production efficiency. Preferably, optimal conditions are attained in the aqueous medium by initially adjusting the concentrations of some or all of the following constituents: nitrogen, phosphorous, vitamin B₁₂, iron chloride, copper sulfate, silicate and sodium EDTA. The pH of the culture medium is continuously monitored, with adjustments, such as carbon dioxide treatments, performed to maintain the pH at a desired level.

Culture of the organisms, for example, can take place in open or closed systems, or a combination thereof. Open systems are preferred because of significant reductions in capital investment, energy input, and operating and maintenance costs as compared to closed systems, and open systems are typically more stable than closed systems. For example, raceway ponds, comprising shallow ponds which are natural or artificial in design, are useful for the cultivation of algae. A preferred culture method for maintaining a dominant strain in culture using an open system is described in U.S. Pat. No. 6,673,592, which is hereby incorporated by reference. Closed systems, including tubes, bags, tanks, or the like can also be used with the methods disclosed herein.

Briefly summarized, the cultivation system comprises a container for holding a culture medium. The culture medium includes an initial aqueous solution and a seed stock of one or more organisms, typically at least one of the organisms is a photosynthetic microorganism. The initial aqueous solution is prepared such that optimal conditions for culturing the photosynthetic microorganisms of interest are established. Once the optimal conditions are established, the aqueous solution is inoculated with a seed stock comprising at least one photosynthetic microorganism. The resulting culture medium is pH controlled in a set range. The pH range will vary according to the needs of the one or more photosynthetic microorganisms. A light source, preferably the sun, delivers light and heat to the culture medium, facilitating the growth of the photosynthetic microorganism culture. Periodically, a percentage of the photosynthetic microorganism culture medium flows through a clarifier to extraction. The medium removed is replaced with recycled medium or a non-sterile medium, such as seawater. The method is continually repeated, thereby providing for uninterrupted production.

Optimal conditions for culturing a selected photosynthetic microorganism are typically established in the aqueous medium. Optimal conditions are those that allow a seed stock of photosynthetic microorganism to grow and out-compete predators, contaminants and other potential scavengers. Creating such a medium allows for the mass production of photosynthetic microorganism outdoors and under non-sterile conditions. Preferably, optimal conditions are attained in the aqueous medium by initially adjusting the concentrations of some or all of the following constituents: nitrogen, phosphorous, vitamin B₁₂, iron chloride, copper sulfate, silicate and Na₂EDTA. The pH of the culture medium is monitored, with adjustments, such as carbon dioxide treatments, performed to maintain the pH at a desired level.

In a preferred embodiment, the present system is used for culturing Chaetoceros sp. as the photosynthetic microorganism. The container holds an aqueous medium having the following starting characteristics: a carbon dioxide controlled pH of about 8.2, a starting nitrogen concentration of at least 3.0 mg N/liter, a starting phosphorous concentration of at least 2.75 mg P/liter, a starting vitamin B₁₂ concentration of at least 5 micrograms/liter, a starting iron chloride concentration of at least 0.3 mg/liter, a starting copper sulfate concentration of at least 0.01 mg/liter, a starting silicate concentration of at least 10 mg SiO₂ /liter, and a Na₂EDTA concentration of 5 mg/liter. The medium is inoculated with a seed stock of Chaetoceros sp. photosynthetic microorganism and exposed to direct sunlight. The photosynthetic microorganism grows in the open environment and is periodically and continuously flowed to the extraction process. This volume is replaced with recycled medium or a non-sterile medium, such as seawater. Culturing is then continuously repeated. The harvested volume is replaced with a new seed stock of Chaetoceros sp. photosynthetic microorganism and culturing is repeated.

While any light source may be used in the present system, culturing the photosynthetic microorganism under full strength sunlight is the most economical option.

A percentage of the culture is periodically harvested. Preferably, about 20, 30, 40, 50, 60, 70, 80, 90, 95, or 99% of the culture volume is harvested at the conclusion of each period. Preferably, about 20% of the culture volume having about 80% of the algae culture is flowed to extraction at the conclusion of each period. In preferred embodiments of the present system and method, the culture is flowed to extraction or otherwise harvested once a day, or approximately once every twenty-four hours. As sterile conditions are not required, the harvested volume is readily replaced with recycled growth medium or non-sterile seed stock of photosynthetic microorganism, such as seawater. The volume is preferably manually harvested or harvested using any acceptable harvesting machine or apparatus.

The container, which may have any acceptable dimensions and be constructed of any acceptable material, and preferably has an open top. Preferably open tanks, such as raceway-type large tanks or ponds are used as the containers. The containers or tanks may be positioned above ground to permit sunlight to be passed through the sides of the containers. Alternatively, the containers or tanks may be positioned within the ground. A transparent, light-passing cover may be positioned over the open top. In one embodiment, the cover is removably positioned over the open top.

By culturing photosynthetic microorganism in the optimal conditions, the production of large quantities of photosynthetic microorganism is possible in a cost effective manner. A single container is situated in an outdoor environment such that the contents of the container are directly exposed to natural light. No artificial light sources or additional transfer tanks are needed. Contaminants and predators are avoided, as the established media conditions allow the photosynthetic microorganism to outcompete and overcome unwanted or detrimental species.

By establishing the optimal culture conditions for Chaetoceros sp. photosynthetic microorganism, the present system provides for an environment where Chaetoceros sp. photosynthetic microorganism out competes other species of photosynthetic microorganism from the culture. That enables Chaetoceros sp. photosynthetic microorganism to be cultured continuously in large, outdoor containers using natural light. The need for labor intensive and costly systems designed to exclude other species from the culture is eliminated. The use of open containers and natural light greatly decreases the costs of cooling and maintenance problems associated with closed systems.

### Harvesting

A variety of methodologies can be used to harvest the photosynthetic microorganisms cultured according to the presently described methods. In one preferred embodiment, the photosynthetic microorganisms are harvested from the culture medium using foam fractionation. This methodology utilizes air bubbles to harvest the organisms. Suitable foam fractionators produce a stream of fine bubbles within the culture medium. A co-current or counter-current system providing the air bulbs can be utilized. Preferably the medium is pumped out of the culture container to a fractionation column, which is vertically arrayed to maximum the harvesting process. As the medium fills and flows through the chamber, it is brought into contact with a column of fine bubbles. The bubbles interact with the photosynthetic microorganisms (biomass), proteins, bacterial contaminants, and other substances and carries them to the top of the column where the bubbles form foam. The fractionated medium can be recirculated in the column for further fractionation or it can be pumped out, preferably back to the culture container. The foam is collected and then condensed into a liquid for further processing. The condensate contains the harvested biomass. A variety of flocculants can be used to enhance the process. Exemplary flocculants include chitosan, ferric chloride, and alum. Some organisms can be induced to produce their own flocculants.

Suitable the fractionators are capable of extracting the photosynthetic microorganisms and other organic compounds from the medium. This action serves to harvest the products of cultivation as well as to improve the quality of the culture medium by removing harmful contaminates. In a preferred embodiment, using foam fractionation can also raise the dissolved oxygen in the medium.

A component of the foam fractionation process is the inclusion of a surfactant. Typically an exogenous surfactant can be added to the culture medium prior art to the fractionation process. Alternatively an endogenous surfactant can produced by the photosynthetic microorganism. For example, Chaetoceros sp. are known to produce and excrete surfactants that can be exploited with the foam fractionation process, particularly when the system is put under stress, particularly nutrient stress. Preferably, the stress is applied to the growing culture prior to harvest, typically approximately one hour prior to harvest. It is contemplated that using an exogenous surfactant can be added to culture media used to grow photosynthetic microorganisms that excrete surfactants, when necessary.

Preferably, the foam fractionation process is at least 80, 90, 95, 98, or 99% efficient in removing the cultured photosynthetic microorganisms from the culture medium. Important control variables for the process include bubble size, air flow rate, cell density, overflow height, and run time. In a preferred embodiment, complete removal or sterilization of the culture medium is not achieved so that the fractionated medium returned to the culture container contains a sufficient amount of the photosynthetic microorganism to reseed the culture for another round of production. If necessary, exogenous amounts of the photosynthetic microorganism can be added to the fractionated medium. Additional nutrients and other components necessarily to allow the preferred strain to grow dominantly can also be added prior to or after the fractionated medium is returned to the culture container. The fractionated medium can be subjected to cavitation prior to return to the cultivation container.

In another embodiment, the culture medium shunted directly to the extraction step without foam fractionation.

### Extraction

Any extraction protocol that permits the efficient isolation of desired components from the fractionate can be used with the presently described invention. Preferably extraction methods that are applied to a moving fluid flow to enable a continuous production process are preferred over static batch processes because continuous production methods significantly reduce the cost of producing finished biofuels or other products.

The choice of extraction technologies will depend largely on the nature of the photosynthetic microorganism in culture. Organic-walled microalgae are suitable to hexane solvent and enzymatic extraction. Silica-walled microalgae (diatoms) however render their own cell walls extremely insoluble. In addition silica creates a physically strong and chemically inert protective covering since the cell walls cannot be attacked enzymatically. The silica cell structure of diatoms such as Chaetoceros sp. enables the use of a variety of cell disruption technologies that liberates the oils and lipids from the cultured organisms harvested during the fractionation process, allows for the isolation of the high-quality silica (diatomite). A preferred cell disruption technology is hydrodynamic cavitation which can be applied effectively to both organic- and silica-wall photosynthetic organisms.

Cavitation is the formation of partial vacuums in a liquid by a swiftly moving solid body such as a propeller or by high-intensity sound waves. The partial vacuums are used to rupture the photosynthetic microorganisms. A variety of different hydrodynamic cavitation technologies are known in the art. For example, U.S. patent application Ser. No. 12/144,539, entitled “APPARATUS AND METHOD FOR GENERATING CAVITATIONAL FEATURES IN A FLUID MEDIUM;” U.S. patent application Ser. No., entitled “ELECTROHYDRAULIC AND SHEAR CAVITATION RADIAL COUNTERFLOW LIQUID PROCESSOR;” U.S. patent application Ser. No. 12/167,516, entitled “APPARATUS AND METHOD FOR PRODUCING BIODIESEL FROM FATTY ACID FEEDSTOCK;” and U.S. Pat. Nos. 5,810,052; 5,931,771; 5,937, 906; 5,971,601; 6,012,492; 6,502,979; 6,802,639; 6,857,774, and 7,207,712 all teach various hydrodynamic cavitation devices, and all of which are hereby incorporated by reference in its entirety.

In a preferred embodiment, a device for creating hydrodynamic cavitation in a fluid is utilized. Typically, the device includes a flow-through chamber having various portions and a plurality of baffles within one of the downstream portions of the chamber. One or more of the baffles is configured to be movable into an upstream portion of the chamber to generate a hydrodynamic cavitation field downstream from each baffle moved into the upstream portion of the chamber.

In another preferred embodiment, a magnetic impulse device for creating hydrodynamic cavitation in a fluid is utilized.

Cavitation (the formation, growth, and implosive collapse of gas or vapor-filled bubbles in liquids) can have substantial chemical and physical effects. While the chemical effects of acoustic cavitation (i.e., sonochemistry and sonoluminescence) have been extensively investigated during recent years, little is known about the chemical consequences of hydrodynamic cavitation created during turbulent flow of liquids.

Hydrodynamic cavitation is the formation of cavitation bubbles and cavities within a liquid stream or at the boundary of the streamlined body resulting from a localized pressure drop in the liquid flow. If, during the process of movement of the liquid, the pressure at some point decreases to a magnitude under which the liquid reaches a boiling point for this pressure (“cold boiling”), then a great number of vapor-filled cavities and bubbles are formed. These vapor-filled cavities and bubbles are called cavitation cavities and cavitation bubbles. Insofar as the vapor-filled bubbles and cavities move together with the flow, they then move into the elevated pressure zone. Then, almost instantaneously, vapor condensation takes place in the cavities and bubbles, and they collapse, creating very large pressure impulses. The magnitude of the pressure impulses within the collapsing cavitation bubbles may reach 150,000 psi. The result of these high-pressure implosions is the formation of shock waves that emanate from the point of each collapsed cavitation bubble. Such high-impact loads result in the breakup of any medium found near the collapsing cavitation bubbles. Collapse of a cavitation bubble near the boundary of phase separation of a liquid-solid particle in suspension results in the breakup of the suspension particles: A dispersion process takes place. Collapse of a cavitation bubble near the boundary of phase separation of a liquid-liquid type results in the breakup of drops of the disperse phase: Cavitation process takes place. Thus, the use of kinetic energy from collapsing cavitation bubbles and cavities is used in our cavitation process to extract the lipids from microalgae and to sterilize the growth medium for reuse.

### Principle of Operation of Cavitation Mixer-Homogenizer Reactor

In its simplest form, basic cavitation consists of the flow-through chamber, with cavitation generator located at the entry. The shape of the cavitation generator significantly affects the character of the cavitation flow and, correspondingly, the quality of dispersing. The optimal cavitation generator design is chosen in a multi-stage cavitator. In general, the cavitation generator works in the following manner The stream of components to be processed under pressure P1 is charged with the aid of an auxiliary pump at the entry of the flow through chamber. Further, the stream flows around cavitation generator, after which, as a result of the localized pressure constriction, a cavitation cavity is formed. This cavity with its tail part comprises numerous bubbles. The cavitation bubbles flow with the stream to the exit of the flow through chamber into the elevated pressure zone P2. In this zone, the cavitation bubbles collapse, resulting in the dynamic influence on the emulsion drops, particles, or aggregate particles in suspension.

However, in our process a precisely calculated engineered design is used in order to maximize the physical principle of a multi-stage hydrodynamic cavitation operation.

### Advantage of Multi-Stage Cavitation

Independent of the physical principle of its operation, the particle size achieved is dependent on one primary parameter in the process of dispersion—the level of energy dissipation in the cavitation reactor and cavitation pump. The higher the level of energy dissipation in the cavitator chamber of the reactor, the smaller the particle size that can be achieved with any given medium.

The preferred multi-stage hydrodynamic cavitation reactor can achieve the smallest particle sizes. The level of energy dissipation in a cavitation reactor is mainly dependent on three vital parameters in the cavitation bubble field: the sizes of the cavitation bubbles, their concentration volume in the disperse medium, and the pressure in the collapsing zone. Given these parameters, it is possible to control the cavitation regime in the reactor and achieve the required quality of dispersion.

In the above examples, the volume concentration of cavitation bubbles was on the order of 10%, which is at the low end of the concentration levels normally achieved in a cavitation reactor. By changing the type of cavitation in the reactor, it is possible to change the volume concentration of bubbles in the field from 10 to 60%, and their sizes from 10 to 1000 μm. The very high levels of energy dissipation produced during the collapse of a large number of cavitation bubbles allows the cavitation mixing pump and multi-stage hydrodynamic reactor to produce a very small particle size and very uniform particle size distribution. The results are produced at 500 psi operating pressures, which makes the equipment safe for a daily processing operation.

For biodiesel conversion application, hydrodynamic two-stage cavitation process is a component mix in the reactor on the molecular level. All components inside of reactor are influenced with high pressure impulses and advanced controlled hydrodynamic cavitation. While processing vegetable oils with necessary components in hydrodynamic reactor the molecules of fatty acids are broken apart with micro-explosions; it results in viscosity decrease, cetane number increase, as well as improved power parameters of the produced fuel. The velocity and quality of the esterification reaction also increase significantly.

The hydrodynamic cavitation technology can be used to convert a variety of organic oils into biodiesel. Typically vegetable oils such as peanut oil, palm oil, soy bean oil, etc., have been subjected to transesterification to produce biodiesel. The cavitation technology discussed above can be used with these vegetable oils to produce biodiesel. The biodiesel can be used neat (B100), mixed with petroleum produced diesel (e.g., B99), and/or mixed with other additives to improve the qualities of the biofuel.

Preferably, the cavitation technology described here is used to extract the oils produced by the cultivated photosynthetic microorganism and convert it into biodiesel and other compositions, like glycerin. An advantage of this technology is that it eliminates the need for harvesting and dewatering steps required in other extraction processes. In one embodiment, a significant portion of the growth medium is directly subjected to cavitation which disrupts the microalgae cell structure and extracts the oils and other components from the microalgae cells. The resulting medium consisting of microalgae oil, microalgae cell biomass, and the harvested medium is flowed through to a separation process for separation.

Hydrodynamic extraction enables the production of low-cost biofuels from microalgae oils because it is easily integrated into an economic and continuous process. The cost of hydrodynamic extraction using a 10 gallon/minute reactor is approximately $0.002 per gallon of fluid processed which is several orders of magnitude smaller than the alternative combined costs of harvesting, de-watering, and existing extraction technologies. New higher flow-rate reactor designs will significantly bring down the costs. Furthermore hydrodynamic extraction does not require the addition and subsequent removal of costly additives or chemicals. Hydrodynamic extraction also enhances the adoption of diatoms for microalgae oil production.

### Separation

Separation methods that are applied to a continuous moving flow to enable a continuous production process are preferred over static batch processes because continuous production methods significantly reduce the cost of producing finished biofuels or other products.

Separation is the process by which various components of an effluent including oil, water, and suspended organic solids are separated into distinct streams for additional processing or disposal. In the processing of photosynthetic organisms after extraction the resulting medium is composed of algal oil, growth medium including water and nutrients, and organic matter from the cell and cell membrane. Separation is required for each of the components for the following reasons—the algal oil for additional processing and conversion into a biofuel product, the growth medium for sterilization and recycling, and organic matter for disposal or potential resale in this case of diatom silica.

The Separation process is designed by using Stokes Law to define the rise velocity of oil droplets based on their density and size. The design of the separator is based on the specific gravity difference between the oil and the wastewater because that difference is much smaller than the specific gravity difference between the suspended solids and water. Based on the design criterion, most of the suspended solids will settle to the bottom of the separator as a sediment layer, the oil will rise to top of the separator, and the wastewater will be the middle layer between the oil on top and the solids on the bottom.

In a preferred embodiment, the separation process is applied to a continuous moving flow and eliminates the need for time consuming settlement.

In another preferred embodiment, the separation unit consists of a Hydrostatic Pressurized Flotation Baffles (HPFB). The mixture enters the HPFB unit where laminar and sinusoidal flow is established and the oils impinge on the flotation baffles surface. As oils accumulate they coalesce into larger droplets, rising upward through the flotation baffles until they reach the top, where they detach and rise to the water's surface. At the same time solids encounter the flotation baffles and slide down into a catch basin.

### Treatment, Enrichment and Recycling

After separation one the components will be the remaining growth medium. This growth medium will consist of water, nutrients, bacteria and unwanted photosynthetic organisms. In typical production systems the growth medium is considered unsterile and potentially hazardous because of the added nutrients and will be disposed. However, this is a costly and potentially environmentally unfriendly.

In this invention the growth medium is treated, enriched and recycled in a continuous moving flow and The lipids and biomass produced from this first round of cavitation can be subjected to subsequent rounds of cavitation that result in the production of biodiesel and glycerin. For example, see U.S. application Ser. No. 12/167,516, which discloses the production of biodiesel from fatty acid feedstock. The fractionated medium can be shunted back to the cultivation container. Also, as discussed above, the culture medium can be subjected to cavitation directly, skipping the foam fractionation step. After cavitation and removal of the product components (e.g., lipids), the medium is returned to the cultivation system. The medium is treated and sterilized to eliminate bacteria and unwanted photosynthetic organisms, additional nutrients are added and infused into the growth medium and the enriched growth medium is flowed back into the cultivation system.

In a preferred embodiment, Ultraviolet light coupled with hydrodynamic cavitation is used to treat, enrich and recycle the growth medium. Ultraviolet light coupled with the unique properties of hydrodynamic cavitation are used to kill bacteria and other unwanted photosynthetic organisms by calibrating the size of the cavitation bubbles, the flow rate and the implosive force. This same calibration is done to break down added nutrients into nano-sized particles so that they are infused into the growth medium allowing for a more uniform distribution. This uniform distribution has the potential advantage of increasing cultivation yields.

The treatment, enrichment and recycling process eliminates the significant costs of disposal associated with typical systems and provides additional cost savings by recycling water and unused nutrients that remain in the growth medium.

### Biofuel Preparation

A biofuel is any fuel that derives from a biological source—recently living organisms or their metabolic byproducts, such as fatty acids from a photosynthetic organism. A biofuel may be further defined as a fuel derived from a metabolic product of a living organism. Preferred biofuels include, but are not limited to biodiesel, biocrude, ethanol, butanol, and propane.

Typical fatty acids include saturated and unsaturated fatty acids. Saturated fatty acids do not contain any double bonds or other functional groups. Unsaturated fatty acids contain two or more carbon atoms having a carbon-carbon double bond. Saturated acids include stearic (C18; 18:0), palmitic (C16; 16:0), myristic (C14; 14:0), and lauric (C12; 12:0). Unsaturated acids include those such as linolenic (cis, cis, cis C18; 18:3), linoleic (cis, cis C18; 18:2), oleic (cis C18; 18:1), hexadecanoic (cis, cis C16; 16:2), palmitoleic (cis C16; 16:1), and myristoleic (cis C14; 14:1).

It is known that thermal and catalytic cracking of medium (C10-C14) and/or long (greater than C16) chain fatty (naturally synthesized carboxylic) acids, coupled with separation and purification technologies, can produce a mixture of chemicals suitable for use as a fuel or a fuel blendstock, most specifically as components in diesel, kerosene, aviation turbine, and motor gasoline fuels. An example of a method for deriving fuel from biomass is described in U.S. patent application Ser. No. 11/824,644 (METHOD FOR COLD STABLE BIOJET FUEL), which is herein incorporated by reference. U.S. patent application Ser. No. 11/824,644 describes a process for producing a fuel from biomass with a cloud point below −10 C. The present invention describes a process that can produce short chain carboxylic acids and carboxylic acid esters while also producing materials suitable for use fuels or fuel blendstocks. Combining production of short chain carboxylic acids and acid esters with fuel or fuel products offers the ability to produce not one but two beneficial products using one set of cracking parameters.

In the cracking process, energy is used to break carbon-carbon bonds. Once broken, each carbon atom ends up with a single electron and free radicals. Reactions of the free radicals can lead to various products. The breaking of large organic molecules into smaller, and more useful, molecules can be achieved by using high pressures and/or temperatures with a catalyst (catalytic cracking) or without (thermal cracking). Previous research has shown that medium (C10-C14) and long (greater than C16) chain fatty (naturally synthesized carboxylic) acids are compatible for the cracking processes, using either thermal or catalytic cracking. These techniques have been used in previous inventions and studies to modify the chemical composition of biodiesel. However, they have not been used to produce commercial quality short chain carboxylic acids and/or esters.

Biomass (including lipid and fatty acid feedstocks) is produced by the disclosed continuous cultivation methods. The biomass may “cracked” using a variety of methods, preferably cavitation. The products of the cracking process are dependent upon the conditions of cracking and the original composition of biomass and the gaseous environment present in the cracking reactor. The cracking conditions are varied based on detailed chemical analyses in order to produce the optimal mixture of short chain carboxylic acids and fuel components.

A catalyst can be used to improve the yield of desirable products, decrease the formation of unwanted products, or increase the efficiency of the cracking reaction due to lower pressure, temperature, or residence time requirements. Catalysts include but are not limited to zeolites, carbon and rare metals such as palladium, niobium, molybdenum, platinum, titanium, aluminum, cobalt, gold and mixtures thereof.

The cracking output is subjected to a variety of processing and purification steps dependent upon the material generated. The output from the cracking reactor depends upon the specific reactor design employed.

In one embodiment of the invention, a biologically generated lipid from photosynthetic organisms, or a transesterified derivative thereof is heated to a temperature ranging from 300 C. to 500 C., in a cracking reactor, at pressures ranging from vacuum conditions to 3000 psia, in the presence of a gaseous environment that can contain an inert gas such as nitrogen, water vapor, hydrogen, a mixture of vapor-phase organic chemicals or any other gaseous substance, for residence times ranging from one to 180 minutes to affect cracking reactions that change the chemical composition of the contents of the cracking reactor. The vapor leaving the cracking reactor (crackate), is subjected to downstream processing that can include cooling and partial condensation, vapor/liquid separation, extraction of by-product chemicals by solvent extraction or other chemical/physical property manipulation, in-situ reaction, distillation or flash separation to produce an acceptable transportation fuel, such as aviation turbine fuel or diesel fuel. The liquid and solids leaving the reactor (residue) are subjected to downstream processing that can include cooling or heating, liquid/solid separation, vapor/liquid separation, vapor/solid separation, extraction of by-product chemicals by solvent extraction or other chemical/physical property manipulation to produce an acceptable fuel by-product or byproducts. Unreacted and partially reacted material separated from either the crackate or the residue may be recycled to the cracking reactor, routed to additional cracking reactors or used in other processes.

The following examples are offered to illustrate but not to limit the invention.

### Example 1

### Culture and Harvesting of Chaetoceros

### Source of Chaetoceros

The fertilizer mix described below was added to unfiltered seawater collected in a near shore lagoon or tide pool environment in Hawaii. Air was bubbled through the seawater. Within two to three days a mixed species bloom of microalgae would develop in the water. After a microalgae bloom was established of at least 1.0×10⁵ cells/ml the management method described below was begun. After three to five days the resulting algae culture would be at least 99% Chaetoceros sp.

### Culture Management Method

Each day approximately 20% of the culture volume was removed one hour after sundown and replaced with raw seawater. The fertilizer mix described below was added to the culture after addition of the new seawater. The cultures had unfiltered air bubbled up through the culture from the bottom of the water column. A pH controller would open a solenoid valve when the pH rose above 8.2 allowing carbon dioxide to bubble through the culture until the pH went below 8.1 when the carbon dioxide flow was shut off. The light path used in the cultures was a minimum of six inches and a maximum of 3 feet. The temperature of the cultures was not controlled and would reach 35 C or above daily.

### Any Culture Vessel Can Be Used

A large variety of culture vessels were used from square tanks of 6″ depth to 18″ diameter cylinders of 5 foot depth. The Chaetoceros sp microalgae could be maintained as the dominate species in all types of culture vessels. The shorter the light path the higher the cell density reached. The highest cell densities of 8-9×10⁶ cells/ml were reached in 6″ depth one liter aquariums that were placed outside under the tropical sun in Hawaii with no temperature control. The temperature in these cultures would reach over 35 C.

Because the culture technique is not tied to any type of culture vessel the technique can be readily scaled to larger size tanks.

### Fertilizer Mix

A modified Guillard's f/2 mix was added to the cultures. This consisted of the standard recipe in the table below with the following modifications. A starting nitrogen concentration of at least 3.0 mg N/liter, a starting phosphorous concentration of at least 2.75 mg P/liter, a starting vitamin B₁₂ concentration of at least 5 micrograms/liter, a starting iron chloride concentration of at least 0.3 mg/liter, a starting copper sulfate concentration of at least 0.01 mg/liter, a starting silicate concentration of at least 10 mg SiO₂/liter, and a Na₂EDTA concentration of 5 mg/liter.

Standard Guillard's f/2 ingredient list. To culture diatoms additional Na₂SiO₃ is necessary.

| Nutrients | Concentration (mg/liter) |
|---|---|
| NaNO₃ | 75 |
| NaH₂PO₄•H₂O | 5 |
| Na₂SiO₃•9H₂O | 30 |
| Na₂C₁₀H₁₄O₈N₂•H₂O (Na₂EDTA) | 4.36 |
| CoCl₂•6H₂O | 0.01 |
| CuSO₄•5H₂O | 0.01 |
| FeCl₃•6H₂O | 3.15 |
| MnCl₂•4H₂O | 0.18 |
| Na₂MoO₄•2H₂O | 0.006 |
| ZnSO₄•7H₂O | 0.022 |
| Thiamin HCl | 0.1 |
| Biotin | 0.0005 |
| B₁₂ | 0.0005 |

### Harvesting Method

The portion of the culture that was removed was stored in a harvesting tank. The culture in the harvesting tank was circulated through a foam fractionator column from evening until morning. The column was at least five feet tall with the water flow moving downward in the column. Air was bubbled upward through the column from the bottom creating foam at the surface of the water that contained concentrated photosynthetic microorganisms. This foam was collected from the surface of the water. This foam upon condensing into a liquid contained approximately 3% dry matter content.

The resulting foam was condensed and then run through a 20″ diameter continuous centrifuge operating at 10,000 rpm. The concentrated algae paste had approximately 30% dry matter content.

### Yield

The culture technique described above supplied concentrated Chaetoceros sp. microalgae paste for over four years of continuous production to a University of Hawaii research project. The final system consisted of sixteen 18″ diameter by 5 foot depth polycarbonate tubes for a total system volume of 3200 liters (light path of 18 inches). This system daily supplied on average 300 grams of 30% dry matter (70% water) Chaetoceros paste. This is equivalent to 34.7 kg/acre/day dry matter or 12,669 kg/acre/year dry matter (assuming 12 inch deep ponds).

### Extraction and Separation

Cultivation medium from the cultivation process above was flowed into a commercial clarifier so that an aqueous medium consisting of 10% of the total cultivation medium volume with a 3% dry matter content was then directly flowed into a hydrodynamic cavitation reactor that processed 10 gallons per minute at 500 psi operating pressure for Hydrodynamic extraction. Three Hundred and Twenty (320) liters were processed in under 9 minutes. Total processing cost was $0.17.

The Hydrodynamic extraction extracted over 98% of the Chaetoceros sp. estimated ash free dry weight oil content and after separation using a bench-top gravitational hydro static baffle separator produced over 2.9 liters of 99% pure microalgae oil at a cost of $0.06 per liter of oil ($0.22 per gallon of oil). This compares to $2.91/liter for extraction using current technologies, not including the cost of the required de-watering steps.

We claim:

1. A method for the continuous cultivation, harvesting, and extraction of a photosynthetic microorganism, comprising:
a) culturing a photosynthetic microorganism in a growth medium and the photosynthetic microorganism therein under conditions that facilitate the reproduction of the photosynthetic microorganism to a desired density;
b) flowing part of the cultivated medium in an aqueous phase into an oil extraction process while leaving part of the cultivated medium in the cultivation container for self-inoculation;
c) extracting, through a continuous aqueous flow of the cultivated medium process, the oils in the photosynthetic microorganism by rupturing the cell membrane and liberating the oils;
d) separating, through a continuous aqueous flow of the extracted medium, the algal oils, recyclable medium, and biomass from the extracted medium;
e) flowing the recyclable medium in an aqueous phase into a treatment and enhancement process;
f) treating and enhancing, through a continuous aqueous flow of the recyclable medium, the recyclable medium for reuse as new growth medium;
g) flowing the new growth medium in an aqueous phase into the cultivation container; and
h) repeating steps a) to g).

2. The method of claim 1, wherein the cultivation container is closed or open relative to the external environment.

3. The method of claim 1, wherein the photosynthetic microorganism is a marine diatom.

4. The method of claim 3, wherein the marine diatom is a Chaetoceros species.

5. The method of claim 1, wherein the medium is optimized by the addition of one or components selected from the group consisting of:
a. nitrogen to produce a nitrogen concentration of at least 3.0 mg N/liter;
b. phosphorous to produce a phosphorous concentration of at least 2.75 mg P/liter;
c. vitamin B₁₂ to produce a vitamin B₁₂ concentration of at least 5 micrograms/liter;
d. iron chloride to produce an iron chloride concentration of at least 0.3 mg/liter;
e. copper sulfate to produce a copper sulfate concentration of at least 0.01 mg/liter;
f. silicate to produce a silicate concentration of at least 10 mg SiO₂/liter; and
g. Na₂EDTA to produce a Na₂EDTA concentration of 5 mg/liter.

6. The method of claim 1, wherein the culturing container is subjected to sunlight.

7. The method of claim 1, wherein the culturing container is subjected to an artificial light source.

8. The method of claim 1, wherein the culture medium is flowed into extraction at approximately 24 hour increments.

9. The method of claim 1, wherein the cultivated medium is clarified in a continuous flow prior to flowing into extraction;

10. The method of claim 1, wherein the microalgae oils are extracted using hydrodynamic cavitation.

11. The method of claim 10, wherein hydrodynamic cavitation is achieved using a multi-stage cavitation chamber.

12. The method of claim 10, wherein hydrodynamic cavitation is achieved using magnetic impulse cavitation.

13. The method of claim 11, wherein the lipids are subjected to an additional round of cavitation for transesterification into biodiesel.

14. The method of claim 1, wherein the recyclable medium is treated and enhanced by the addition of nutrients and CO₂, then processed through hydrodynamic cavitation, and then processed through ultraviolet light.

15. The method of claim 1, wherein the recyclable medium is treated and enhanced by the addition of nutrients and CO₂, then processed through hydrodynamic cavitation, and then processed through ultraviolet light.

16. A method for producing a biofuel, comprising:
a) harvesting a feedstock according to the method of claim 1, wherein the feedstock is one or more fatty acids;
b) fractionating the feedstock using hydrodynamic cavitation to produce lipids; and
c) converting the lipids to the biofuel.

17. The method of claim 14, wherein the lipids are subjected to an additional round of cavitation for transesterification into biodiesel.
